(19) United States
(12) Patent Application Publication
(10) Pub. No.: US 2023/0264585 A1
(43) Pub. Date: Aug. 24, 2023

(54) Charging System for Electrical Vehicles

(71) Applicant: Elijah Abron, Silver Spring, MD (US)

(72) Inventor: Elijah Abron, Silver Spring, MD (US)

(73) Assignees: Teresa Abron, Silver Spring, MD (US); Elijah Abron, III, Brooklyn Park, MN (US)

(21) Appl. No.: 17/676,177

(22) Filed: Feb. 20, 2022

(51) Int. Cl. B60L 53/52; B60L 53/20; B60L 58/10; B60K 7/00; B60L 8/00

(52) U.S. Cl. CPC B60L 53/52; B60K 7/0007; B60L 8/006; B60L 53/20; B60L 58/10; B60L 2200/32

(57) ABSTRACT

Air power auxiliary alternators comprising a recovering system for capturing moving kinetic air energy, Using alternators for charging the batteries and supplying power to the electrical system, plus other vehicle components and the automobile’s motor. The charging system has a voltage regulator unit and a power control inverter. Giving power back to the auxiliary drive motor that electrically powers the battery and the drive process. The system is a non-contact powering unit that uses not take away from the vehicle’s electrical system the kinetic energy air from a moving vehicle. Multiple alternators force air into the pelonis intake, which is mounted in the front of the vehicle and arranged to transform this air into a rotating motion and charge the ion battery. This energy of the rotating movement of the kinetic energy action to electrical energy power for E.V. vehicles or trucks with trailers, an. This auxiliary electric trailer motor is connected to the trailer’s rear wheels, and a controller controls the motor with electrical power and torque to drive the trailer.

### DESCRIPTION

The present innovation relates to generating electrical energy for an electric vehicle using kinetic air power from a moving vehicle and transforming it into mechanical energy that is used to apply force air on the_pelonis impellers of the alternator units from the atmosphere by applying pressure on the pelonis housing impellers connected to a shaft of the rotating alternators. One or more turbines can be added to the alternator shaft attached to an alternator or using gears or belts connected to the generator shaft to produce electricity through its Momentum transfers from the alternators from the rotation of the pelonis impellers. This Momentum has thrust that is generated as a reaction to the acceleration of the air column.

### BACKGROUND

### Field of the Disclosure

The present disclosure relates to providing auxiliary energy for passenger vehicles, pickup trucks or trailer to help provide additional power for the vehicle, or at least a portion of the energy being reapplied back into the charging system by creating an efficient auxiliary charging system that works while the vehicle moves on the road and simultaneously charges the vehicle batteries. The unit creates electrical energy to help power the vehicle; this auxiliary charging system also works on gasoline pickup trucks and diesel trucks with trailers (a vehicle that has shafts); this power replenishes the vehicle’s electrical system for connecting to the system charging the batteries, and working on an entirely different separate charging systems for charging batteries.

The electricity for consumption by electric motors or the vehicle to drive a portion of the vehicle while the vehicle is traveling on the road; today’s electric cars that are being created today has a short mileage range because the weight of the batteries does not allow them to travel a longer distance. They are trying to solve this problem by adding more batteries that are not the answer; using wasted air energy from the vehicle is a better alternative that will help extend the battery life and its charging ability and range of the car. The captured energy is a byproduct of the air to the auxiliary charging system. The two-or-more alternator, the system captures the wasted kinetic energy airflow from the vehicle that is driven and catches air in front of the vehicle; using the kinetic energy of each is a byproduct of the vehicle’s movement.

### Description of the Related Art

This kinetic energy system is a more desirable way than adding more heavy batteries to achieve more mileage for a more extended period of travel. This kinetic energy system performs a more efficient, cleaner output by obtaining power from wasted kinetic energy from the airflow from the electric vehicle, deriving locomotion power from electricity is often received from an energy storage device within the electric vehicle. The energy storage device could be an array of batteries or an energy storage and containment device. Hybrid electric vehicles include regenerative charging, which captures energy from the vehicle braking system and traditional charging stations, energy storage devices, and electricity to the E.V. Vehicle. An electric vehicle, battery-electric Vehicle, or hybrid-electric Vehicle is an automobile propelled by one or more electric motors, using only energy stored in batteries.

### SUMMARY OF THE INNOVATION

Various embodiments of the systems, methods, and devices within the scope of these appended claims have several aspects. The description below describes some prominent features without limiting the content of the appended claim sent features.

According to one aspect of the present innovation, there is provided a constant-speed two alternator for powering the batteries at a continuous output, the output shaft comprising two alternators or generators with air airflow that is rotating the squirrel_ pelonis housing turbines impellers and creating a voltage; also, a voltage regulator to control the output voltage; and at At least one or more alternators or generator units are inline on a standard shaft.

According to another aspect of the present innovation, there is provided a fixed pitch impeller connected to the pelonis housing shaft within the pelonis housing of the unit for generating power from the alternator. Comprising: at least an alternator installed in a pelonis housing, a motor-powering unit, and the alternator’s unit is a non-connected powering system powered by kinetic energy winds.

According to a third aspect of the present innovation, there is provided a method of extracting power from the_generator movement, while driving, the two alternator speeds up from the airstream in front of the vehicle, causing the shaft to rotate the alternators; that is, on the shaft, the higher the airspeed, the fast the air stream to the alternators shaft,

Embodiments of innovation provide significant advantages in helping with today’s energy problems. Electric vehicles have some of the same disadvantages as before; the “Battery life” decreases travel time for vehicles. This unit will generate electrical power while traveling on the road and charge for two and a whole travel period. The power alternator unit is handy in many different applications.

The air-charging alternator unit takes up wasted air energy. It converts it into electrical energy and the aerodynamic force from the rotor impellers, which work like an airplane wing or helicopter rotor impeller. When air flows across the edge, the air pressure on one side of the impeller decreases. The difference in air pressure across the two-sided impeller creates lift and drag.

### BRIEF DESCRIPTION OF DRAWINGS

FIG. 1 is a block diagram showing configurations of a charging generators unit for an electric vehicle according to an embodiment of the disclosure.

FIG. 2 illustrates the first air intake of the charging generator unit according to a first air intake an embodiment of the disclosure.

FIG. 3 illustrates a drawing of the Impellers/Turbine connected to a shaft and charging generator unit according to the embodiment of the disclosure

FIG. 4 illustrates a vehicle with an example of the air intake vent’s locations on the vehicle for air intake to the generator units to generate electrical energy for the charging generator units according to the first pelonis air pelonis intake 77 embodiments of the disclosure.

FIG. 5 illustrates a section of exhaust air exit 100 of the charging generator turbine/ impellers with high and low air pressure according to the first pelonis air pelonis intake 77 and area exhaust air exit 100 of the embodiment of the disclosure.

FIG. 6 illustrates a section of exhaust air exit 100 generators located on the high-pressure outgoing air of the charging generator unit according to a section exhaust air exit 100, an embodiment of the disclosure.

FIG. 7 illustrates a side view and front view of a charging generator impeller/turbine impellers unit according to the embodiment of the disclosure.

FIG. 8 illustrates a side view and front view of a charging generator impeller turbine with an Impeller or impellers, having blades both curved and straight impellers blades, well as multiple small and large deep pockets, according to an embodiment of the disclosure.

FIG. 9 illustrates a side view and front view of a charging generator impeller with oval turbine impellers, According to the embodiment of the disclosure, some have a blade within a blade.

FIG. 10 illustrates the charging generator unit oval impeller deep pocket’s view mounted within the pelonis housing 55 according to section 55 and exhaust air exit 100 section of an embodiment of the disclosure.

FIG. 11 illustrates a block diagram showing configurations on a vehicle with four or more charging generator units on vehicle 90 capturing a singular battery array or separate auxiliary batteries and assess in power to the electric Vehicle 900, according to an embodiment of the disclosure.

FIG. 12 illustrates a diagram of a pelonis cabinet 55, showing that the enclosure is close on both sides 34 and 32 and outer pelonis housing with the shaft 52 mounted into the bearing 136 on the outer side of pelonis housing 55, turbine blades 36, as shown in the pelonis housing 55. unit also indicates the pelonis intake 77 and the exit air 100, and the airflow thru the unit,

FIG. 13 illustrates a diagram of a motor that is connected to the shaft, the rear axle, and power-receiving from the motor controller module and battery supplying authority to the rear trailer 302 axel a motor according to the third embodiment of the disclosure.

FIG. 14 illustrates a drive motor connected to the rear trailer 302 rear axle with electrical power coming from the motor controller and charging generator unit 900, according to the third, an embodiment of the disclosure. the illustration of the power connection from the motor controller, according to the third embodiment of the disclosure, the view in FIG. 14, is a view for explaining an example of an electric vehicle charging unit mounted within the body of the vehicle that charges creates a charge according to an embodiment of the disclosure.

FIG. 15 illustrates a drive motor 670 that may or may not be directedly connected to the transmission or may or not be connected directed the trailer rear wheels with a u-joint 444; the motor also may be installed in line with a shaft on both ends of the motor.

### DETAILED DESCRIPTION OF THE INNOVATION

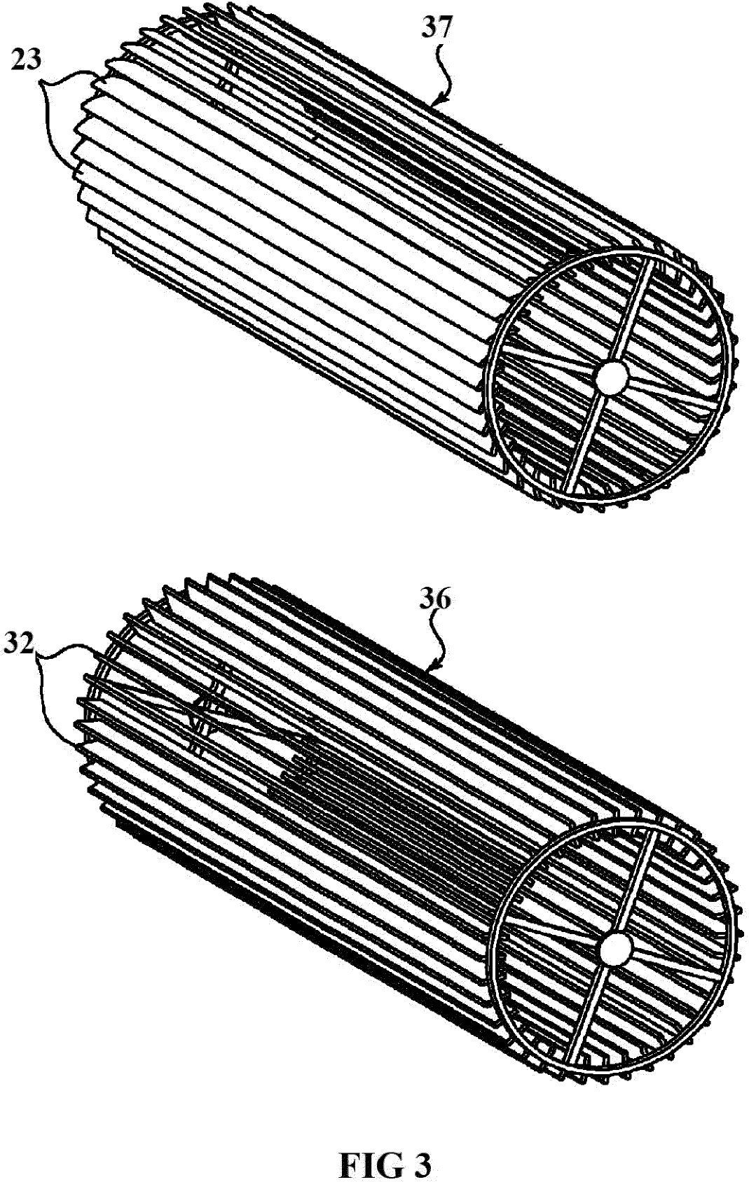

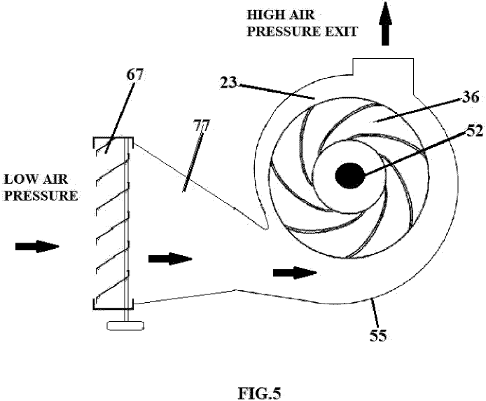

The air charging unit with two alternators, 48A, and 48B, works on a simple principle: the air moving from vehicle 300 pushes the air aside as it moves on the road. Vehicle 300 is wasting air energy air to the side, taking a loss to the batteries bank just by driving on the road at 30 miles per hour means that the wind speed is 30 miles an hour, pushing on vehicle 300. The alternator 48A will be the talking point of the details of the innovation. The charging system uses the movement of air pressure to generate electricity. The airflow is being forced into the unit thru the intake tunnel opening to the_pelonis fan impellers that apply pressure on the fan impellers 36 to start shaft rotation. The two alternators 48A and 48B that is now turning (As shown in FIG. 5), the high-pressure air pass-thru into the vehicle Grills 94 or 93 or a scoop 99, front side or on the side of a car, which can collect the wind that inner the pelonis housing impeller, 36 cavities of the turbine blade 36, this higher pressure-wind; add more speed; the higher pressure of the wind, the increased air pressure that. contacts the_pelonis impellers, the alternator reaches the correct RPM speed, and the unit will start producing electricity samples in (FIG. 3) (squirrel_turbine blades, the main components are blades, backplate, and impellers).

This innovation relates to a wind turbine for generating electricity for an electric vehicle, Vehicle 300, and trucks; this unit produces electrical energy for charging one or more batteries 19. This energy can charge electric vehicles 300 and other hybrid vehicles 300 for household use. The wind turbine is designed as a portable or stationary charging system that works on kinetic energy. The structure and operation of these wind turbines are as follows:

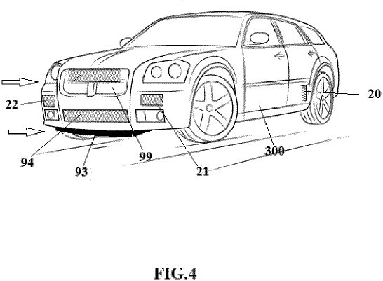

FIG. 4 At the front of vehicle 300, under grill 94 on grill 93, the air inlet flow scoop 99, 20, 21, 25, 39, 22 option to collect air during driving is contained in a Funnel-shaped tube (1), shielded by a grid 93 with a mesh. In the available space,

Kinetic energy describes the process by which kinetic energy is used to generate mechanical power to create electricity. this difference in dimensions and pressure between inlet 77 and outlet exit 100, the exit size is a smaller dimension, and the airflow 133 is forced. through the outlet exit 100 and the released airflow must be able to escape quickly at the back of the-pelonis intake housing 100 is located at the beginning of 77 of pelonis housing 55; the_pelonis housing impellers assembly; when talking about the squirrel pelonis housing, we will only be talking about pelonis housing 55 as a single unit that releases airflow 133 thru the pelonis housing 55 units and diverts out of the exit port 100 within the vehicle, wind power is transformed into mechanical energy that is used to recharge the battery of vehicles or for specific tasks such as electric boat vehicles, electric vehicles, electric trucks, trailers 302, or any larger vehicle or large non-EV trucks of all models can use this process of converting kinetic energy into electrical_energy for recharging batteries 19.

Using the aerodynamic force from the rotating impeller unit works like a wing or a helicopter rotor impeller. When air flows across the edge, the air pressure on one side of the impeller Decreases the difference in air pressure across the two sides’ impellers, creating. Both lift and drag. The force of the lift is stronger than the drag, and this causes the_impeller blades 23 inside to rotate. The shaft 52 is connected to the alternator, either indirectly or directly, if it is a direct drive alternator such as 48A and 48B in series with gears such as a gearbox 17 that speed up the rotation and allow for a physically smaller alternator 48A. This translation of aerodynamic force to the process of an alternator creates electricity.

When the alternator 48A and 48B unit has a fixed pitch impeller within the pelonis. turbine blades 36 and 37; the rpm increases the voltage and increases when the rpm is. too high, the automatic louvers 600 airflow control unit slowly closes off the airflow to the pelonis impellers, slowing down rotation will decrease the electric output and the rpm of the shaft; the alternator will automatically reduce its production, so it is necessary to monitor the rpm on the charging unit because the alternators or multiple alternators are connected serial or parallel. Therefore, Overspeed may be a problem: the two alternator’s constant speeds may have a louver 600 that will automatically coarsen the double alternator shaft at 52 rates to maintain the rpm and prevent the alternator from overcharging the output of voltage during charging. The fixed pitch two alternator unit impellers are ones where the output voltage is adjusted to a set point, and by the louvers, 600 that controls the impeller blades’ 23-speed automatic changes during running.

The turbine impeller blade 23 is flat or bent at the end to fully absorb the airflow. This allows for an extensive range of power settings and two alternator speeds to be set, meaning that the most efficient operating point can be selected based on a wind speed of 60. miles an hour, the alternator is a unit that can supply only A.C., Output voltage 220 V, frequency 50/60 Hz, the shaft speed at 3600 rpm at speed is 60 miles a ho; the Alternators provide electric power to vehicle battery at 11.5 kW an hour for a 60-kWh battery needed about 6 hours to charge the battery fully. The battery charger 123 supplies power to the battery, and the voltages regulator 150 regulars, the voltage to the inverter 127 is also used to convert A.C. To D.C., creating a three-phase. Current AC Current on a twin system with two A.C. units with a connecting port 277 for A.C. or D.C. input power: this input plug is for the charging station or at-home charging that connects to the charging system 900. The charging system 900 also is connected to 277, the same power lines as the charging station and home charging plug system. This same system of charging also charges the auxiliary battery 31.

Fix pitch two pelonis impeller/ turbine impeller output can be adjusted. Mechanically by a governor to maintain a constant speed irrespective of the air condition. Since the alternators are connected to the regenerative braking motor 30, which is linked to the rotation speed of the alternators is a direct function of the motor speeds. For this reason, the double alternator speed on the alternator will vary with vehicle speed; the motor can speed up or slow. Down the shaft on the generator or the vehicle 300 or a trailer 302 the driveshaft, the motor has a setting by which it is a governor. The angle at that the impeller is relative to the size of the vehicle is. Mounted determines how much lift and drag (thrust and torque) is produced on the alternator unit; depending on the E.V. vehicle’s size, the resultant angle of attack is a function of the rotational velocity of impeller blades 23 and the forward speed of the primary motor two alternators.

The air to the alternators produces electrical energy, and harnessing this clean, free-air energy that is a widely available renewable energy source-to generate electric power for recharging battery 19 while using battery 19 to operate other components in the vehicle, such as a light control system, and powering the motor,

An air alternator charging unit turns air energy into electricity using the aerodynamic force from the turbine impeller blades 23. When air flows across the impeller, the pressure on one side of the edge decreases. The difference in air pressure across the impeller’s two sides creates lift and drag. The force of the lift is stronger than the drag, and this causes the turbine to spin. The turbine connects to the alternator directly (if it is a direct drive alternator) by a shaft 52 and a series of gear 17 that speed up or slow down the rotation and allow for a smaller alternator. This translation of aerodynamic force to the process of an alternator creates electricity.

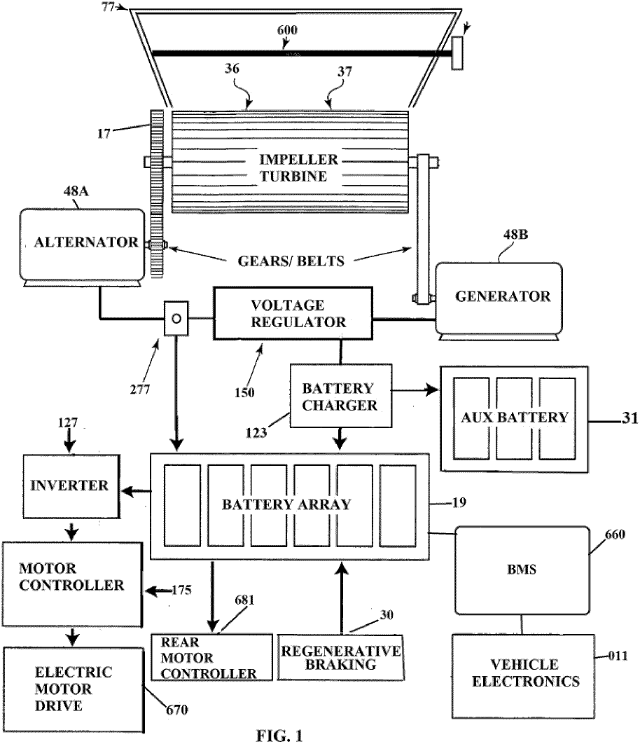

The alternators 48B and 48A in FIG. 1 is an alternator that is mounted to a framing. A unit that mounts to the vehicle’s inner frame that holds the alternators and pelonis housing along with a shaft 52 that controls the alternators, there are many other positions the unit can be mounted in or on a vehicle, as shown in FIG. 4,

As stated before, the force of the air is the energy needed to make the alternator rotate. The rotation can come from one source: air pressure from the air or wind power; both will Eventually create a rotating force on the alternators within the pelonis housing.

In FIG. 1, the air is a low-pressure air applied to two aalternators 48A and transformed to a high air pressure force spinning shaft 52 attached to the alternator shaft 52. The two alternator 48A absorbs the energy, applies it to the alternator, and uses it to create rotational motion.

as a vehicle moves on the road, it’s central electric motor controller 175 powers the car and the air turn the two alternator 48A shaft 52 and pull in the air to create thrust, as the two alternators, 48A rotates to generate thrust and moves faster, causing the air to have a higher air pressure and faster movement to be applied to alternator shaft 52, causing shaft 52 to rotate more quickly. The rotation of shaft 52 drives the inner workings of the alternator to turn faster and start producing electricity.

The alternator current is created due to a law of electromagnetism called the Law of Induction, this Law states that a wire conductor that moves a magnetic field creates an electric current, and the strength of the wind is equal to the rate of change through the magnetic field. So, the faster the copper coil within the alternator rotates, the more electric current will be created.

The electricity that is produced can be extracted from the alternator and sent to the power Inverter 127. The method of retrieving the electrical energy once the alternator is turning and creating electrical power created by the movement of the alternators, the power invertor 127 that is supplying power to the battery charger 123 that will provide electrical charging power back to the battery from the battery charger 123.

Note: in this case, we get electric energy produced clockwise or counterclockwise direction (the movement of air is causing shaft 52 to spin),

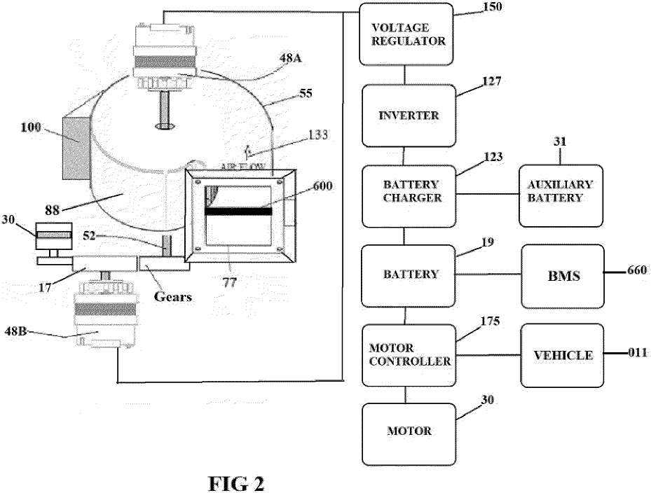

The operation of the airpower alternator can be understood by referring to FIG. 1, FIG. 2 illustrates the rotation of the alternators 48A. or generators will have an alternator within a cycle denoted using the rotation of the connecting shafts 52 attached to the generator 48B and the alternators 48A by shaft 52. The rotation of the drive shaft 52 provides control of the cycle that is generated by force from the air that was developed from the motor, and alternators 48A rotational movement of the shaft 52 provide for power extraction to the alternator.

The power alternator transforms kinetic energy by capturing the air from moving vehicles, as rotation, the rotation from the two alternators 48A or like a squirrel_pelonis housing 55 and turbine blades 36 and blade 37. The process of the two alternator 48A is used to produce. Electrical energy for recharging batteries 19 when the vehicle is moving.

In other embodiments, an alternator 48A impeller 36-angle help control the speed of the alternator, 48A impeller unit 36 and shaft 52 to accommodate changes in airspeed. Also, a gearbox, as shown in FIG. 1 can change the rotational speed of the alternator output shaft.

In other embodiments, the two alternator 48A or pelonis house can provide adaptation to different weather conditions (with an appropriate impeller angle control unit) to provide adaptation to other air conditions.

In other embodiments, the constraining link may be extendible. In FIG. 1, the drive shaft 52 is the two alternator 48A. This allows the alternator to extract power from the rotation of the shaft in a clockwise or counterclockwise rotation. Which can remove energy from? Kinetic energy flows from left to right, as shown in FIG. 16. This is beneficial for collecting energy for a moving vehicle 300; the air inner thru the front grills 94, 93, and 99 and the adjustable air scoops vents capture the atmosphere from the air scoops on the side of the vehicle that has been taken from a different location on the vehicle to add more electrical. Output power (as shown in FIG. 4.) 20, 21, 22, 25, and 39 side-mounted air intake scoops.

In one application of embodiments of the innovation, the braking motor 30 is also used as a speed controller by controlling the speed of the turbine by speeding up in low air pressure and slowing down when the air pressure is too high, and stopping and locking the two alternators to keep them from moving when regenerative braking motor 30 is parked when the charging system is not needed.

In another application of embodiments of the innovation, this process applies to the Vehicle 300 with turbine charging unit 900. As Vehicle 300 moves down the roadway, the air.. is forced in through the front grilles and controlled by a louver 600 and motor 30 that controls the_speed, impeller 36, which turns the alternators and starts applying power back into the electric Vehicle 300 batteries as the Vehicle 300 moves along the highway, the air supplies force against the squirrel cage blades within the pelonis housing, the impellers 36, causing rotation on shaft 52, the strength of the air causes the alternator turbine 36 to turn and start the charging. the process as the electric power is generative; it flows to the voltage regulator to be adjusted, and the regulator controls the voltage to a set output, the battery charging 123 controls the input power to the batteries 19, the charging process can occur even if vehicle 300 is moving and there is a secretin amount of the available wind?

In another application of embodiments of the innovation, all gasoline or diesel trucks and non-E.V trucks require an alternator that is connected to the motor for recharging the batteries 19 and maintaining power, as a motor vehicle is moving at a reasonable speed, the two alternator charging systems will produce electric power; this innovation does not require a connection to the fossil fuel-burning engine to operate.

The charging assembly unit is indicated by the numeral 900; the charging assembly 900. Includes an impeller turbine blade 36 with shafts 52 and bearing 136 that is contained to generators. The generators within the pelonis housing 55 are mounted to the outer portion of the 16 and have an exterior wall and the 16 have a rectangular or round intake scroll. The shaped length extends from a leading first end edge 77 to the ending edge exit 100 of the outer wall 16 to an opposite section end edge 20 of the outer wall 16. The enclosure includes a top portion of 76 and a cutoff of 78. Air scoops 94,93,99,25, vehicle 300; pelonis housing 55 consists of a first side. Wall 32 and a side wall 34 bearings. Section of the peripheries of the first side wall 32 and the side wall 34 are close walls with bear blocks with a sshaft52 running thru to the other side. Of the unit,

connected to the opposite sides of the outer wall 16. The first side, wall 32, has a first. straight an edge portion of 26, and the side wall of 34 has a section straight edge portion of 28. The first straight edge the piece is 26, and the section straight edge portion is 28; the first side of the wall is 32, and the side wall is 34, respectively, are also positioned on opposite sides of an outlet opening exit 100, which is preferable, but not necessarily, taper rectangular or round, of the pelonis housing 55 with the outer wall 16, the first end edge 100, and the section end edge 28 defining the outlet opening of 77, which preferably, but not necessarily, has a taper rectangular. Or a scrolling body configuration.

The first side wall 32 includes a shaft and bearing shaft and bearing 136, which is through the first side wall 32. The section side wall 34 consists of a section circular the turbine blade 36, shown in FIG. 16, through the section side wall 34. A shaft and bearing shaft and bearing 136 and the section circular aperture blade 37 are coaxial. Aligned and function as the air inlet openings of pelonis housing 55. This inlet system for charging assembly 36 is highly efficient. However, single or two inlets may be utilized.

A first curved portion extending between the first opening 77 includes a first circular shaft. In the pelonis section, the curved portion extends between the side wall and the circular chamber, with the impeller aperture located within the pelonis housing. A Motor 30 of the charging assembly 900 is. preferable. Still, not necessarily; auxiliary regenerative braking and motor 30 have two functions: stopping and sending regenerative back into the system. The other is for speeding up the system in low air. The movement is used for dynamic braking, as shown in FIG. 1. regenerative braking motor 30 is a motor. The frame pelonis housing 55 for motor 30 is preferably used to speed up or slow down the impeller. Or reverse as a dynamic braking unit 30, the low-pressure air 133 airflow path into the series of air flowing to the turbine impeller or impeller blades 23, as shown in FIG. 2.

However, any of the myriad motors will suffice with this present apparatus. The drive shaft 52 of motor 30 is attached to the turbine impeller shaft, as shown in FIG. 1, through the section series of attachment mechanisms 84, nut and bolt combinations, through any openings in the bearing (not shown in FIG. 2.) There is a drive gear 17 or belt that is attached to the Impeller (as shown in FIG. 1) 36 to allow the turbine shaft 52 to rotate the turbine/ impellers 36, as shown in FIG. 5. The drive gears 17 may optionally include a first connecting portion attached by an attachment shaft 52, e.g., nuts and bolts 84, which. Connects the bearing 136 for the turbine blades. Rotates the shaft 52.

In this illustration, shaft 52 has a bearing on both sides of pelonis housing 55 to support the shaft 52 bearings 136, e.g., bearings 136, allowing rotatable movement for the turbines that are mounted on shaft 52, which connects the stationary gears 17 on the shaft 52 is attached to the impeller or impellers. The Motor 30 of the charging assembly 900 is preferably, but not necessarily, an axial flux motor, as shown in FIG. 2. Optimally acts as a regenerative braking motor 30 is a pancake motor. The outer wall edges 28 of the frame pelonis housing 55 for motor 30 is preferably angled to allow a clear airflow path into the series of airflow impeller blades 23, as shown in FIG. 2.

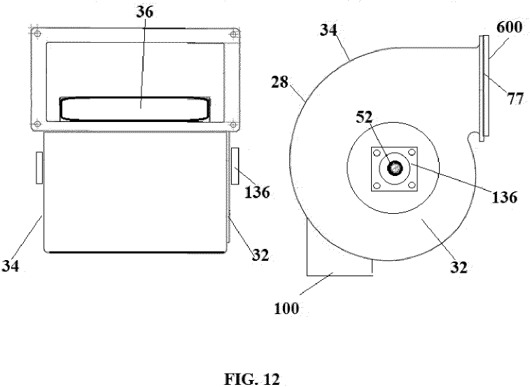

However, any of the motors will suffice with this present apparatus. The motor 30 is attached to shafts 52 and 17, as shown in FIG. 3 through the section. Series of attachment mechanisms 55 body, nut, and bolt combinations, through 8 holes openings, nuts 86, as shown in FIGS. 12 and 2. A drive gear 17( not shown) is attached to the impeller turbine shaft 52 to allow the rotation. To rotate impeller turbine blades 23, as shown in FIG. 5, for controlling the speed of the generator by speeding up and using power from the auxiliary battery 31 thru the power line (shown in FIG. 1). The charging assembly 900 is constructed in such a manner that allows for the wiring associated with the generator and battery connection. The regenerative braking motor 30 is to be run through a motor. Controller (not shown),

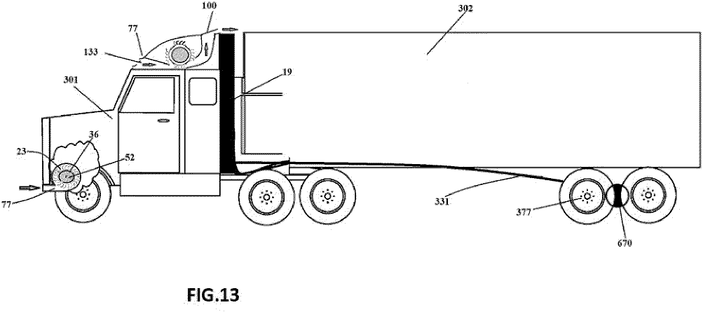

FIG. 13 illustrates the diagram of a semi with a trailer 302 with a motor 670 that is connected to the differential is connected to the rear axle 377 with a bearing universal joint 444 that is connected to a motor controller 175 in the illustration; there are two generating units in the system for sending power to truck 301 can have as many as ten charging units if the demand call for that amount of energy controls the output power that is generated from the power unit 900 that powers the system in the same manner as a vehicle charging system that’s receiving capacity to supply battery 19, the motor that is connected to the rear wheels (not shown) from the controller 681 modules, a lithium-ion battery 19 that is mounted on the back of a semi-truck tractor 301, the speed of trailer 302, is connected to the truck tractor 301 accelerator via cable 331 supplying power and control to the rear trailer axel motor 670, according to the third, an embodiment of the disclosure.

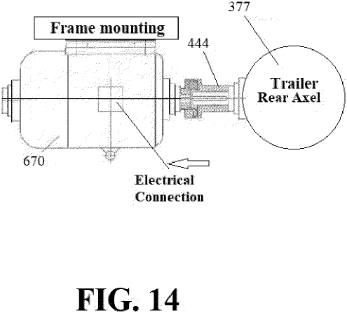

FIG. 14 illustrates a drive motor 670 connected to the rear trailer 302 rear axle 377. differential with electrical power coming from the motor controller 681 and charging generator units 900, according to the third embodiment of the disclosure. the illustration of the power connection from the motor controller 175, according to the third embodiment of the revelation, the view in FIG. 14 is a view for explaining an example of an electric vehicle charging unit mounted within the body of a semi-truck 301 or trailer 302 that is being powered by the charging system 900 and supplying power to the rear axle wheels motor 670 of the semi-trailer, the charging system creates a charge according to the embodiment of the disclosure.

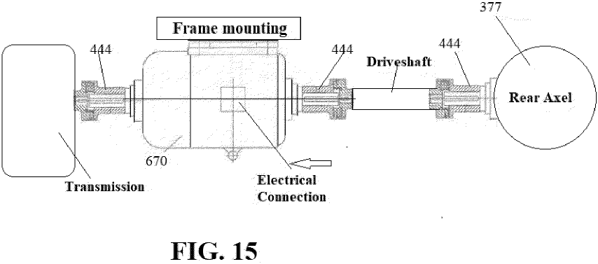

FIG. 15 illustrates a drive motor 670 connected to a transmission with a u-joint 444; on another end of the motor 670 is a u-joint 444 and a shaft with another u-joint. 444 relating to the rear axle 377, the rear trailer 302 rear axle with electrical powering from the motor 670. controllers 681 and charging generator unit 900, according to the third, an embodiment of the disclosure. The illustration of the power connection to the motor 670 is driving the rear axle 377 of the trainer.

Reference Numerals * Generators 48A and 48B; charging assembly 900; air intake 77. funnel pelonis 55; funnel air exhaust 100; battery 19; voltage regulator 150; auxiliary battery 31; battery charger 123; inverter 127; motor controller 175; dynamic braking motor 30; low-pressure air 133. dynamic braking motor 30; impeller blade 37; gearbox 17; electric vehicle 300; battery 19; includes a battery 19, voltage regulator 150, a charging unit 123, dynamic braking motor 30, impeller turbine blades 23, louvers 600, vehicle 300. bearing block 136; high-pressure air 99; nuts and bolts 84; low-pressure air 133; connecting portion 52; shaft coupling 28; motor controller 681; plug 277; impeller blades 36. rear motor controller 681. impeller blades 37; rear drive motor 670; u-joint 444; rear motor controller 681;

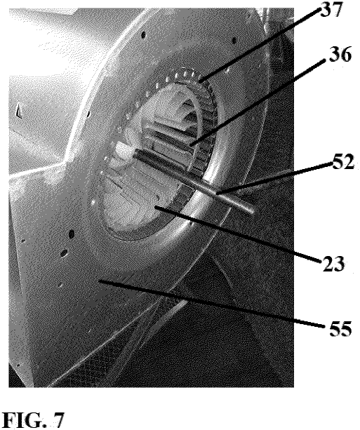

FIG. 1 illustrates a block example of the electric self-charging system of charging assembly 900. according to an embodiment of the disclosure. As shown in FIG. 1, the self-charging system 900 includes generators for charging the battery with a rotatable turbine impeller 23 (shown in FIG. 7,) a dynamic braking motor 30, and an electric vehicle 300, also referred to as a vehicle 300, to be subjected to recharging.

According to an embodiment, the charging assembly 900 can also create electrical energy in a stationary park position, the vehicle is also can charge by a wind blowing within the environment to start also rotating by an operator to produce electrical power for the Vehicle 300 batteries, and aloud the vehicle does not use charging facilities and travel without visiting a charging station. The charging assembly 900 is internally provided with a battery 19 for supplying electrical power to vehicle 300 and battery 19, and the auxiliary battery 31 absorbs all the overcharging currents from generators, the generator’s charging assembly 900 has a high-capacity output; for example, the output from the generators supplies power of 30 kwh at 180.42 amps. The charging assembly 900 charges battery 19 with the charging capacity received from the generator in a moving position into the wind, autonomously moving to the status of the charging battery 19 of the electric Vehicle 300, thereby supplying the charging power to the charging battery 19 within the electric vehicle 300.

According to an embodiment, the charging assembly 900 includes a primary pelonis intake 77 tube pelonis 55, of which the outer appearance is alternately changed (or transformed) between a first air pelonis intake 77 and a section exhaust air exit port 100. In the disclosure, the first air pelonis intake 77 is defined as an air intake port 77, which is a larger opening (that may be round or square) for making the main body of the charging assembly 900, rotate the impeller within the funnel, as the air moves through the moving cause, the moving of the impeller 23, and a section of the exhaust air exit port. 100 is defined as the high-pressure exhaust air exit port 100, a port for air (wind) to exhaust air exiting charging assembly 900, authorizing the electric Vehicle 300 batteries, in stationary mode, the low-pressure wind 133 passes thru the funnel tubing and exhaust air exit port 100 as a high-pressure wind 99. Here, a section of exhaust air exit port 100 has a smaller area to exhaust air to exit port 100, the funnel, which is occupied by the main pelonis 55 while charging the operation, then the first air intake 77. The intake port of the impeller is achieved to have a structure stable enough to move in moderate wind pressure or the like a storm with high wind pressure while the charging assembly 900 is rotating the turbines.

Meanwhile, the electric vehicle charging assembly 900, according to an embodiment of the disclosure may further include at least one generator, one voltage regulator, one battery, and one motor controller 175 (shown in FIG. 1). Further, the electric vehicle charging assembly 900. may include several charging units (as shown in FIGS. 4 and 15) installed in a particular location where the unit can be mounted on the vehicle.

unit output was a 30 kWh at ( generator current rating (three phases A/C) 120 v higher amps at 240 volts 45.55 amps, then time that by four, that would become a very high amps output, that more units can be mounted to the vehicle the more on an input of power plus the Vehicle 300 (As shown in FIG. 4) can catch wind from all sides of the vehicle. The output unit can be an alternator or generator having A.C. or D.C. Output; the output voltage can be 120 A/C, 240 A/C, and can accommodate different voltages for different motor controllers 175, an application for controlling the charging assembly 900. This application may be controlled by a BMS 660 (Battery Management System) for the management of the battery and the charging facilities of the charging system unit 900 and distributed through the electrical system in the Vehicle. The power applied to the motor controller 157 controls the electric Vehicle 300. It can be charged by an overload of current generated from the charging assembly unit 900 and the charging generator units.

Below are various embodiments where the main pelonis 55 charging assembly 900 of the charging generator unit is changed into a wind collecting unit will be described in the accompanying. Illustrations. FIG. 2 illustrates the first air pelonis intake 77 funnels of the charging generator unit according to a first air intake pelonis intake 77 embodiments of the disclosure, in which FIG. 2 is a perspective view of the charging assembly 900 having the first air pelonis intake 77 also shows with louvers 600 that are mounted at the front entrance of the pelonis intake 77 and controlled by a stepper. motor (that is not shown) charging assembly 900 that is controlled by a stepper motor (not shown) to restrict the airflow 133 into unit 900, FIG. 3 and FIG. 5 are a front-side View of the charging assembly 900 in FIG. 2 and FIG. 3 of the charging assembly 900 in FIG. 3.

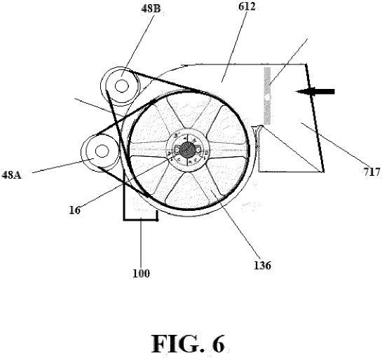

FIGS. 5 and 6 illustrate a section of exhaust air exit 100 port of the charging generator, a unit according to the first air pelonis intake 77 embodiments of the disclosure, in which FIG. 5 is a perspective view of the charging assembly 900 having a section exhaust air exit port 100, and FIG. 6 is a side view of the charging assembly 900 with a generator mounted on the exit port 100, where the air pressure is at its maximum highest pressure.

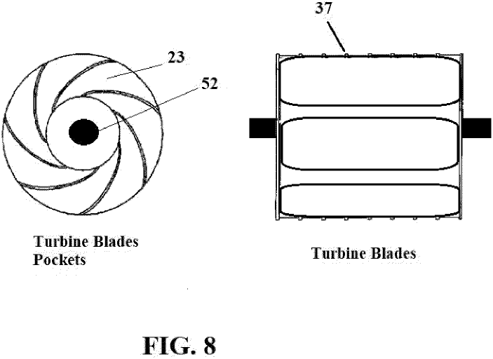

FIG. 5, The main pelonis 55 of the charging assembly 900, according to an embodiment of the disclosure includes a plurality of pockets 38 on the impeller rotor bodies, which are relative to the example shown in FIG. 8 of the charging assembly 900, the first air pelonis intake 77 inners the thru the louvers 600 that adjusts the airflow into the pelonis intake 77 once the air inner the funnel moves thru the tapered horn of 77 can be made of metal or plastic that is attached to the pelonis 55 pelonis housing that is connected to the exit port 100 of the unit; the turbine may have a plurality of impellers blade 37 on the body of the rotor; blade 37 are extensively spaced apart from each other, and the tapered funnel is attached to the pelonis 55 and significantly becomes smaller as it contacts the body and continues to taper as it moves to the exit and connections, the turbine blade 37, catching the air and pushing on the impeller rotor impeller blades 23 and blades 37, which will be described later.

In the first air pelonis intake 77 embodiments, the plurality of funnel bodies includes a first air intake pelonis intake 77 pelonis 55 and a section exhaust air exit 100 enclosure pelonis 55 coupled to the first air pelonis intake 77 enclosure pelonis 55, as shown in FIGS. 2 to 6. The first air pelonis intake 77 chambers pelonis 55 and/or a section exhaust air exit port 100 enclosure pelonis 55 may have a round or square exit port. The exhaust air exit port 100 funnels from the pelonis 55 have a smaller opening than the intake. The clearance of a typical vehicle, for example, a larger vehicle, needs more amps, so more air is necessary for the charging assembly. 900 to enter under the Electric Vehicle 300 while having a section exhaust air exit 100 port.

The charging assembly 900, according to the first air pelonis intake 77 embodiments of the disclosure, one end portion of a section exhaust air exit port 100 is coupled to move up and down, i.e., slide along the lengthwise direction on a pelonis intake 77 of the first air intake pelonis intake 77 pelonis 55. The first air pelonis intake 77 enclosure pelonis 55 may selectively stand up as one end portion of a section exhaust air exit port 100 enclosure pelonis 55 slides along the pelonis 55 surface 55 between the first air pelonis intake 77 and section of funnel pelonis 55.

According to an embodiment, the pelonis intake 77 of the first air pelonis intake 77 enclosure pelonis 55 may be provided with at least one louver 600, as shown in FIGS. 2 and 5, to guide the first intake of the air into the pelonis intake 77 to the pelonis 55 to adjust the airflow. Into the generator unit 900 to speed up or slow down the generator and the voltage output. Further, one end portion of a section exhaust air exit port 100 enclosure pelonis 55 of unit 55 in pieces and areas to provide at least one or more impeller turbines (as shown in FIG. 3) that move the generators units,

As the transformation of air turns the turbine blades 36 and gives it moves within the body 55, corresponding with the generators 48A and 48B starts to create electric energy from the moving air across the turbine blades and pasting the exhausted air to the exhaust air exit port 100 thru 100 exit port opening, specifically, one end portion of a section exhaust air exit port 100 from the funnels that connected to the pelonis 55 that moves the air from the front to the back, i.e., along within the first air pelonis intake 77 funnels.

According to the first air pelonis intake 77 embodiments, the main body is 55 of the charging generator. The intake louvers 600 control the speed of the air, and the dynamic braking system 30 by opening and closing operations. The generator impeller blades 23 turbines are provided as a transformation of the energy from the wind into the unit (see FIG. 5) in the main pelonis 55, the conversion charging assembly 900 is included together with a dynamic motor (as shown in FIG. 1) in a configuration of controlling the speed of unit 900. as Shown in FIG. 1). As established in the first air intake is 77 according to the first air pelonis intake of an embodiment corresponds to a port where a section exhaust air exit port 100 enclosure pelonis 55 supports the first air pelonis intake 77 main pelonis 55 as one sliding end portion of a section exhaust air exit port 100 enclosure pelonis 55 is coupled to a predetermined position on the input 77 of the first air pelonis intake 77 enclosure pelonis 55 in the state that the first air pelonis intake 77 enclosure pelonis 55 stands up as taper inclined at a predetermined angle.

The main pelonis 55 of the charging assembly 900 includes turbine blades 36 with deep pocket 37 rotating by air to move the turbine blades 36 and blade 37. Other components in the drawing are the battery 19 for holding the electrical energy and an inverter 127 for changing the electrical power from A.C. to D.C. or verse, a battery charger 123 for charging batteries 19 and 31, also two generators that have an output for D.C. power or A.C. power; there are two turbines units on shaft 52 or gear 17 ( as shown in FIG. 1)

According to an embodiment, the charging assembly 900 may be provided in such a manner that one turbine blade 36 is attached to shaft 52 within the first pelonis intake of 77 enclosure pelonis 55 and a section exhaust air exit port 100 enclosure pelonis 55, as shown in FIG. 1. The rotating rotor blades 36 or blade 37 with a rotating motor 30. A reversing controller is included in moving unit 30. The reversing of the current that flows to the motor. It may be applied to reversing the rotation of the charging assembly 900 on the output power of the charging assembly 900, affecting rotating rotor blades 36 or blade 37.

The charging assembly 900 is changed in Port, and the size of the ground space is occupied by a a plurality of blade 37 rotating rotors blades 36 as a section exhaust air exit port 100 enclosure pelonis 55 slides. In the charging assembly, 900 has the first air intake of 77, according to the first air intake 77, an embodiment of the disclosure, one end portion of a section exhaust air exit port 100 enclosure pelonis 55 is coupled to the pelonis intake 77 and of the first air pelonis intake 77 enclosure body 55 at a position where space is occupied by four rotating turbine blades 37 has a square port of which width and length are the same (e.g., a width of L and height of L), as shown in FIG. 4.

The preceding square is formed by virtually connecting the rotating turbine blades 36 to the pockets 37, and it is easy to control the direction of the moving charging generator units 48A and 48B, i.e., steer the moving charging assembly 900 by controlling revolutions per minute (RPM) of each of a plurality of rotating turbine blades 36. According to this embodiment, steering, the effect is created by maintaining each RPM of the rotating turbine 37. without physically changing the direction of the rotating rotor of 36 or 37.

Meanwhile, a section exhaust air exit port 100 port according to the first air pelonis intake 77, an embodiment may correspond to a port in which a section of exhaust air exit 100 enclosure pelonis 55 port like a flat plate is disposed of in parallel with the ground, and the first air pelonis intake 77 enclosure pelonis 55 is port-like a flat plate, and standing is vertically coupled to a section exhaust air exit port 100 funnels pelonis 55, as shown in FIGS. 5 and 6. According to the first air intake, 77 embodiment, a section exhaust air exit 100 port 100 of the charging assembly 900 has an outer appearance that the first air pelonis intake 77 enclosure pelonis 55 and a section exhaust air exit 100 enclosure pelonis 55 are coupled to have a crossa section like in the charging assembly 900 has a section exhaust air exit 100 port, as shown in FIG. 6, a section exhaust air exit 100 enclosure pelonis 55 is horizontally disposed to enter under Vehicle 300. Therefore, it is a connector to the charging assembly 900 provided in the first air pelonis intake 77 enclosure pelonis 55 is connected, i.e., docked to the power-receiving battery 19 of the electric Vehicle 300, thereby achieving charging for the electric vehicle 300.

According to the disclosure’s first air pelonis intake 77 embodiments, the connector to charging assembly 900 is provided in the first air intake pelonis intake 77 pelonis 55. As shown in FIG. 5, the connector to the charging assembly 900 may include a connector cover unit. 900 provided in the pelonis intake 77 and the first air intake pelonis intake 77 pelonis 55. Here, the connector cover unit 900 is openable, and the open connector cover unit 900 may be provided with, for example, a first air intake 77 connecting section pelonis 55, such as a connection. The power receiving battery 19 of the Electric Vehicle 300 is provided with a section exhaust air exit 100 connecting portion, such as a port into which the first air intake 77 connecting section port connection can be attached. According to an embodiment, a section exhaust air exit 100 connecting portion pelonis 55 may be mounted near the bottom side of the vehicle.

The louver 600 attached to section 77 is automatically opened/closed. and is controlled by a stepper motor (for controlling the louver’s opening and closing) so that the first air pelonis intake 77 connecting section 55 and a section exhaust air exit 100, connecting portions that can couple with each other, supplying power to the electric vehicle 300. In other words, as shown in FIG. 6, the first air pelonis intake 77 connecting section 55 port like a connection is attached into a section exhaust air exit 100 connecting portion port like a jack so that the connector 48B charging assembly 900 of the charging assembly 900 and the power receiving battery 19 of the electric Vehicle 300 can connect. Then, the electric Vehicle 300 is. charged with power from battery 19 is provided inside the charging generator units 48A and 48B.

The coupling form between the connector 48B charging assembly 900 of the charging assembly 900, and the power-receiving battery 19 of the electric Vehicle 300 is not limited to the structure described in FIGS. 5 and 6 but may have various configurations capable of supplying power. In other words, FIGS. 5 and 6 illustrate an example that the connection is provided as the first air pelonis intake 77 connecting section 55 in the connector 48B charging assembly 900 of the charging generator units, and the pelonis housing pelonis 55 is provided as the air flows to exit 100 from the connecting portion 55, the body where the the impeller is located, the shaft runs from one end of the pelonis housing pelonis 55 to the other side of the body pelonis housing, the power generator created the electricity received by the battery 19 of the electric vehicle 300. Alternatively, the jack may be provided in the connector 1 unit 900, and the connection may be provided in power received from the battery array 19. From the generator 48A and 48B charging power.

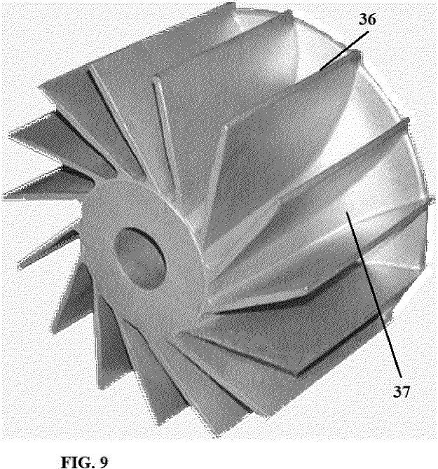

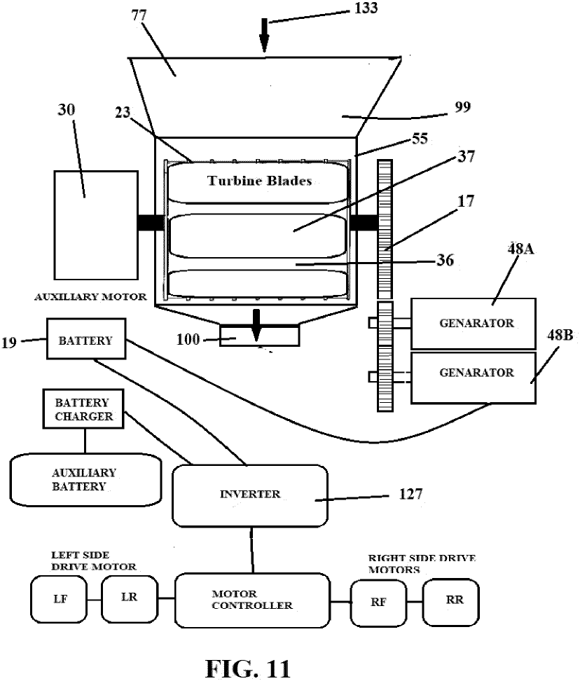

Further, as necessary, the charging power may be supplied by, for example, energy. Transfer using an electromagnetic field without a direct connection between the charging assembly 900 and the electric vehicle 300. Referring to FIG. 6, the charging assembly 900 has the outer section appearance of the exhaust air exit 100 according to the first air intake. 77 embodiment of the disclosure occupies a smaller tunnel leading from the electric vehicle 300 than the first air pelonis intake 77 because a section exhaust air exit 100 funnel body 77 enters within the electric vehicle 300. During the charging process, the airspeed moves with the flow of the vehicle. FIGS. 7 to 9 illustrate the first air pelonis intake 77 of a charging assembly. 900 according to a section exhaust air exit 100 embodiment of the disclosure, in which FIG. 5 is a perspective view of the charging assembly 900 having the first air pelonis intake port 77, FIG. 8 is a side view of the charging assembly 900 in FIG. 5, and FIG. 9 is an illustration of the charging assembly 900 turbines unit, FIG. 5. Charging assembly 900 to FIG. 12 illustrates a section exhaust air exit 100 of the charging assembly 900 according to a section exhaust air exit 100 embodiments of the disclosure, in which FIG. 5. charging assembly 900 is a perspective. View the charging assembly 900 having a section exhaust air exit 100 port and FIG. 11.

The charging assembly 900, according to an embodiment of the disclosure, includes a plurality of funnel bodies 77 and 100, of which relative positions are changed to alternate between a first air pelonis intake 77 and a section exhaust air exit 100 port. For example, the charging assembly 900, having the first air intake 77, decrease or increase over to a section exhaust air exit 100 as the plurality of funnel bodies 77 and 100 are gradually tapered apart from each other, or the charging assembly 900 has a section exhaust air exit 100, decrease or increase the first air pelonis intake 77 as the funnel and the bodies 55 how The 100 come close to each other and reduce in size, which will be described later.

In a section exhaust air exit 100 embodiment, the plurality of central bodies includes a first air intake 77 pelonis 55, and a section exhaust air exit 100 enclosure pelonis 55 coupled to the first air pelonis intake, 77 chambers pelonis 55, as shown in FIGS. 7 to 12. The first air pelonis intake 77 enclosure pelonis 55 and a section exhaust air exit 100 enclosure pelonis 55 may be port-like a flat plate. The first air pelonis intake 77 chambers pelonis 55, and a section exhaust air exit 100 enclosure body 55 has a thickness lower than the minimum ground clearance of a typical vehicle: for example, the thickness of about charging assembly 900 to enter under the Electric Vehicle 300 while having a section for exhaust air exit 100 port.

In the charging assembly 900, according to a section exhaust air exit, 100 embodiments of the disclosure, the plurality of funnel bodies 77 and 100 are coupled to each other. Rotatable concerning an axial rotation line corresponding to the first air pelonis intake 77. The first air pelonis intake 77 enclosure pelonis 55 and a section exhaust air exit 100 enclosure pelonis 55 may selectively stand up depending on the rotation at a coupling portion unit 900.

According to an embodiment, a first air pelonis intake 77 ends of the first air pelonis intake 77 enclosure pelonis 55 and a first air pelonis intake 77 with exhaust air exit section 100 on the pelonis 55, assembled into the coupling unit of 900, may be provided with clamps or made in one whole section as a side section of the unit, top 34 and bottom 32 of unit 55 pelonis housing. The clamping or screwing makes the first air pelonis intake 77 enclosure connected to the pelonis 55 and a section exhaust air exit 100 enclosure pelonis 55 coupled with the shaft 52 and bearing and line. And clamped at each seam on the unit,

According to a section exhaust air exit 100 embodiment, the charging assembly 900 is switched between the first air pelonis intake 77 and a section exhaust air exit 100. As shown in FIGS. 7 and 8, the first air intake 77, according to a section exhaust air exit 100 embodiment, corresponds to a port were the funnel bodies 77 and 100 are concerning the axial rotor line to get closer to each other so that the funnel bodies 77 and exhaust air exit 100 can be supported on the ground by section exhaust air exit 100 end section thereof. In the first air intake, 77 port 77, the first air intake pelonis intake 77 pelonis 55, and a section exhaust air exit 100 port and pelonis 55 may have a slight taper angle or a scrolling body like a squirrel cabinet with the side close with bearing mounted on them while supporting each other. According to a section, exhaust air exit port 100 of the embodiment, the first air pelonis intake 77 of the charging assembly 900 has an outer appearance like the number “6 ”and, thus, the first air pelonis intake 77 port. The larger end of the body, 77, may also be called the first air intake port 77.

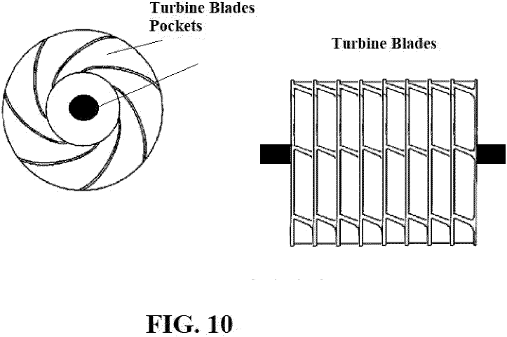

According to an embodiment, the charging assembly 900 may be provided so that one or a pair of rotating rotors can be attached to the body section 55 to exhaust. Air exit 100 enclosure pelonis 55, as shown in FIGS. 9 to 7. The rotating rotor or rotors together with a rotating motor 30 for reversing braking to slow the unit down. The charging assembly 900 has the first air pelonis intake 77 according to a section exhaust air exit 100, an embodiment of the disclosure, as shown in FIG. 9, the rotor turbine impeller pockets grade at an angle that corresponds to the position of the air in the pockets of the impeller, which helps occupy the force to the Impeller; FIG. 10 is a diagram of turbine blades with 36. impellers assembled with deep curl impellers showing two views of the turbine impeller, 36 impeller fronts view, and side view with shaft 52 within the center of the impeller in both drawings.

the dynamic braking motor 30 to control the speed of the moving charging generator unit and the moving charging assembly 900 by regulating revolutions per minute (RPM) of each. Of the plurality of rotating turbine blades 36 and impeller unit 23. According to this embodiment, the louvers 600 effects are created by controlling the airflow to increase or decrease the RPM of the moving rotation 36 without physically changing the angle of the moving rotor 36. Specifically, as shown in FIG. charging assembly 900 section exhaust air exit 100 according to exhaust exit air 100 embodiment corresponds to a port in which the funnel bodies 55 and 36 are rotated concerning the axial rotation line so that the bodies.

55 and 100 can be disposed of on the same plane. In other words, a section of exhaust air exit 100 of the charging assembly 900 may correspond to a port in which a quarter of the exhaust. Air exit 100 exits thru the body of 55 to the exit port 100 like a rectangle opening that is disposed horizontally or vertically from vehicle 300, from the first air pelonis intake 77 thru the body 55 part like a rectangle or square horizontally coupled to a section exhaust air exit 100 port on the body of 55. According to a section exhaust air exit, 100 embodiments, a section exhaust air exit 100 of the charging assembly 900 has an outer appearance that the first air pelonis intake 77. connected to an enclosure pelonis 55 and a section exhaust air exit 100 enclosure pelonis 55 are coupled to have a cross-section like a horizontal line or a Chinese character. Thus a section exhaust air exit 100 may also be called a port.

In the charging generator units, charging assembly 900 has a section exhaust air exit 100 port, as shown in FIGS. 11 and 12, the first air intake, pelonis intake 77, is connected to pelonis 55, and a section exhaust air exit 100 enclosure pelonis 55 are horizontally disposed on the ground to enter under the electric vehicle 300. Therefore, a connector 48B charging assembly. 900 is provided on the first air pelonis intake 77 sides of the first air pelonis intake 77 enclosure pelonis 55 vertically stand up and are then connected, i.e., docked to the power receiving battery 19 of the electric vehicles 300, thereby achieving charging for the Vehicle 300.

According to a section exhaust air exit, 100 embodiments of the disclosure, the connector 48B charging assembly 900 is provided in the first air intake, pelonis intake 77, and rotor enclosure 55. As shown in FIG. 12 unit 900, the connector 48B charging assembly 900 may include a connector 441 ( shown in FIG. 12) provided at the first air pelonis intake 77 sides. Of the first air intake pelonis intake 77 pelonis 55. For example, the connector box unit 441 is. provided with an opening connected to the funnel unit 77 and provides the first air pelonis intake 77 connecting section to pelonis 55 in the opened connector cover unit 44. The power received. by battery 19 of the electric vehicle, 300 provided an area exhaust air exit 100 connecting to the tapered pelonis housing 55, which connected to the exit port 100 from the first air pelonis intake 77 connecting portion 55 is connectable, for example, in which portion 77 is welded or bolted to 55 the body is also mounted to 100; a connection is attached to each section. The generator impellers 36 cavity 37 of with are mounted within the tapered pelonis of 55 and are coupled to. Each other utilizes a shaft, thereby rotating and turning the generators supplying power to battery 19 and vehicle 300 and its electrical system. Specifically, as shown in FIG. 12, the connection corresponding to the first air pelonis intake 77 connecting to pelonis 55 is connected. Fitting to a section exhaust air exit 100 connecting portion so that the connector 48B of the charging assembly 900 and the power receiving battery 19 of the electric Vehicle 300 can connect. Then, the electric Vehicle 300 is charged with energy from battery 19 provided by the charging generators.

The coupling form between the connected generators of the charging assembly 900 and the power receiving battery 19 of the electric Vehicle 300 is not limited to the structure described in FIG. 5. Of the charging assembly 900 and turbine/ impeller in FIG. 8 may have various configurations capable of supplying power. Further, as necessary, the charging power may be provided by, for example, wind transfer using the moving force of the wind or the like without a direct connection between the charging assembly 900 and the electric Vehicle 300. A wind turbine/ impeller generator unit 900 turns the force of the wind energy into electrical. Power by using the aerodynamic force from the wind to the impeller impellers. The turbine/ impeller rotor works like airplane impellers. The vehicle moves into the air creating a breeze that flows across the impellers, causing the air pressure on one side of the impeller to decrease and the other to increase. The difference in the two-air pressure across the two sides of the impeller 23 creates torque and drag. The torque’s force is much stronger than the drag, which causes the spinning rotation. The turbine/impeller is connected to the generator. through a shaft, 52, and a series of gears 17 as a gearbox 17 speed up the rotation and allow for a physically larger or smaller generator. This process of aerodynamic force to the rotation of a generator to creates electricity.

Wind power produces electricity from the wind flowing across the turbine/ impeller. Impellers from the air move on the vehicle. Weather conditions do not impact the wind turbine unit: each turbine generates electricity which runs to the voltage regulator 150, then the inverter 127, and from there to the battery storage 19; a BMS unit control battery storage 19, where it then transfers to the battery charger 123 and the motor controller 175, where its power is distributed thought out the vehicle. The electrical energy is then distributed to the motor. Controller 175, controlling the outpower to the vehicle from wind turbines /impeller and generators 48A and 48B to areas where the energy is consumed. The weight of the vehicle determines the design and size of the impeller blades of the turbine for maximum output,

such as a short impeller with 23 blades or long, Pelonis turbines/impellers with more extended and profound blades capture more air than smaller blades. The output shaft is connected to a stick-on turbine shaft 52 with a series of gears 17 that is comprised of the turbine/ impeller rotor, the main bearing on both sides of the pelonis housing on the drive shaft, and the central shaft 52 is connected to gearbox 17; The gearbox is comprised of the turbine/ The impeller rotor and a central shaft 52 are linked to the gearbox 17 and generators. The gears convert the low speed of the turbine/ impeller to the high torque rotation for the generators to turn into electrical energy: the impeller blades 23 or pockets within the turbine 37 unit together forms the turbine’s/ impeller turbine The controller allows the vehicle to start. And runs at different speeds, from a low rate to a high speed at wind speeds; the controller also controls the speed of the generator to stay around 3600 RPM, which is maintained 60 Hz at 120 volts A.C. or 240 volts @ 240 AC, and apply reverse braking 30 to slow down the generator and inform the voltage regulator 150 to Shut off the voltage input to battery 19 or reduce the voltage. When wind speeds exceed 80 MPH. The controller turns off the voltage from the generator turbine and applies brake resistance. Until a lower wind speed is achieved to avoid damage to various turbine parts. Regenerative braking 30 is the same as brakes on a vehicle.

FIG. 11 is an example diagram showing a configuration of the multi-charging units shown as layout in FIG. 4 diagram shows the intake. The Port’s location on a car is (L.F.) Left front (R.F.) Right Front, (L.R.) Left Rear, and (R.R.) Right Rear: This sample, illustrated in FIG. 4, has several intake ports installed on an electric vehicle according to the pelonis intake 77. An embodiment of the disclosure occupies an area around the electric Vehicle 300 than the first air pelonis intake 77 because the first air intake port 77 funnel section connected to the pelonis 55 of and a quarter exhaust air exit 100 funnels of pelonis 55 mounted within the body of the electric vehicle 300 during the charging. The generator unit 900 can be mounted anywhere on a vehicle. The innovation herein involved the intended that all the subject matter of the above description, that is. Shown with the accompanying drawings shall be interpreted merely as a demonstration by an illustration,

What is claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15, (canceled)

16. (canceled)

17. (canceled)

18. (canceled)

19. (canceled)

20. (canceled)

21. An electric charging system for a motor vehicle that comprises:
a) a pelonis blower pelonis housing with impellers mounted within the front or on the side of a motorized vehicle for.
b) one or more independent electric alternators system within the vehicle that supplies additional electric power to said primary and auxiliary batteries.
c) two or more drive gears or timing belts or chain assemblies extending between impellers shaft and alternators.
d) a battery array within the vehicle connected to the vehicle’s electrical system.
e) an electric motor controller to control the vehicle’s output power.
f) a motor controller for controlling the rear wheel’s output voltage to the rear auxiliary motor.
g) an angular or curved intake on an exhaustible pelonis centrifugal blower compartment with enclosed impellers.
h) said auxiliary battery may be an additional removable electric power to the motor vehicle or home power storage.
I) air is captured when a vehicle such as an automobile, truck, truck trailer, boat, aircraft or a motorcycle that is moving into the air.
j) an air scoop mounted in front of said centrifugal blower compartment in front of said impellers.
k) whereby said air is diverted into the air scoop forcing impellers to turn.

22. The charging system, as recited in claim 21, wherein said the air impellers are located within the pelonis housing.

23. The charging system, as recited in claim 22, wherein said the impeller blower comprises a plurality of large and small impellers.

24. The charging system, as recited in claim 23, wherein said pelonis impeller blower pelonis housing comprises an air intake port and an exhaust port.

25. The charging system, as recited in claim 24, comprises an auxiliary motor controller that is connected to a rear motor.

26. The charging system, as recited in claim 25, wherein said the changing method further comprises a regenerative braking circuit electrically connected to said battery array that supplies additional power.

27. The charging system, as recited in claim 26, wherein said the BMS (Battery Management System) for monitoring and managing the battery’s power input and output performance.

28. The charging system, as recited in claim 27, comprises a non-stationary battery and an auxiliary battery that is not permanently connected to the vehicle.

29. The charging system, as recited in claim 28, wherein said the battery charger for charging the battery.

30. The charging system, as recited in claim 29, wherein said voltage regulator to the regulation of the voltage out to the battery.

31. The charging system, as recited in claim 30, wherein said inverter converts A.C. Power or D.C. to D.C. D.C. to A.C.

32. The charging system, as recited in claim 31, wherein said system is connected to the vehicle’s electrical charging systems.

33. The charging system, as recited in claim 32, wherein said gear is driven to control RPM output and rotation of the shaft.

34. The charging system, as recited in claim 33, wherein said belt-driven control RPM out and rotation of the shaft.

35. The charging system, as recited in claim 34, wherein said chain-driven controls for RPM output and rotation speed.

36. The charging system, as recited in claim 15, wherein said multiple Pelonis mounted together.

37. The charging system, as recited in claim 36, wherein said Pelonis can be mounted in multiple locations thought out the vehicle.

38. The charging system, as recited in claim 37, wherein said the auxiliary battery A storage system can be used as a backup power supply.

39. The charging system, as recited in claim 38, comprises a non-stationary auxiliary battery that can supply electrical power to the rear motor and other electrical components.

40. The charging system, as recited in claim 39, wherein said the auxiliary battery can be used with a power storage system or for additional power to the vehicle.
